(19) United States
(12) Patent Application Publication
(10) Pub. No.: US 2016/0117154 A1
(43) Pub. Date: Apr. 28, 2016

(54) AUTOMATED SOFTWARE INCLUDE GRAPH AND BUILD ENVIRONMENT ANALYSIS AND OPTIMIZATION IN COMPILED LANGUAGE

(71) Applicant: Telefonaktiebolaget L M Ericsson (publ), Stockholm (SE)

(72) Inventors: Antoni Przygienda, Sunnyvale, CA (US); Rameshreddy Mudhi Reddy, San Jose, CA (US)

(21) Appl. No.: 14/522,419

(22) Filed: Oct. 23, 2014

(51) Int. Cl. G06F 9/45

(52) U.S. Cl. CPC G06F 8/443; G06F 8/433

(57) ABSTRACT

Exemplary methods for optimizing a source code base includes generating a dependencies database for a source code base comprising of a plurality of source files, wherein one or more of the plurality of source files comprises a hierarchy of include files, wherein the dependencies database includes dependencies information for each source file and include file, wherein the dependencies information identifies all files that are included by a respective file. In one embodiment, the methods further include modifying the source code base using the dependencies information, wherein the modified code base is more optimized than the source code base, and in response to determining a predetermined optimization threshold has not been reached, repeating the dependencies database generation operation and the source code base modification operation, wherein each time the operations are repeated, the dependencies database generation is performed based on a modified code base from a previous iteration.

### FIELD

Embodiments of the invention relate to the field of processing systems; and more specifically, to the optimization of source code bases.

### BACKGROUND

A significant part of large scale software development is performed today in modern compiled languages such as C, C#, objective-C or C++. These languages allow for definitions and declarations to be separated from the implementation aspect, which is essential for scaling large bodies of code. The concept of including files permits scaling the system via hierarchical includes using specialized statements. These specialized statements tend to create on large system many layered, circular graphs that lead with scale to significant deterioration in build times and fragility of the code due to excessive dependencies. The dependencies do not only show in the include hierarchies but in build description files (e.g. Makefiles) as well.

No solutions exist today that significantly automate optimization of include hierarchies, build description files, or reduction of dependencies, all of which quickly increase complexity that leads to deterioration in code maintainability and build times. Only two solutions exist that claim to indicate only the unneeded first level (i.e., immediately/directly included) definition files for further human analysis. Another solution uses the first level files only to achieve a full combinatorial approach which is infeasible for even very modest size code bases. Thus, there is a need for a fully automated include hierarchy analysis and an improvement to arbitrary depth, i.e., n-th recursion level files (i.e., definition files including other arbitrary definition files, etc.).

### SUMMARY

Exemplary methods performed by an apparatus include generating a dependencies database for a source code base comprising of a plurality of source files, wherein one or more of the plurality of source files comprises a hierarchy of include files, wherein the dependencies database includes dependencies information for each source file and include file, wherein the dependencies information identifies all files that are included by a respective file. The methods further include modifying the source code base using the dependencies information, wherein the modified code base is more optimized than the source code base, and in response to determining a predetermined optimization threshold has not been reached, repeating the dependencies database generation operation and the source code base modification operation, wherein each time the operations are repeated, the dependencies database generation is performed based on a modified code base from a previous iteration.

In one embodiment, modifying the source code base comprises determining include statements of the source code base using the dependencies information included in the dependencies database, wherein an include statement comprises a path-spec and an include path, wherein a combination of the path-spec and the include path identifies an included file and a link path of where the included file resides, and modifying one or more include statements of the determined include statements to reduce a number of variations of the include paths, wherein each modified include statement and its corresponding unmodified include statement identify a same included file and a same link path of where the same included file resides.

In one embodiment, modifying one or more include statements comprises determining a root path of a set of one or more include statements of the determined include statements, and modifying the set of one or more include statements to use the determined root path as the include path. In one embodiment, modifying the source code base comprises identifying a circular dependency using the dependencies information included in the dependencies database, wherein the circular dependency occurs when two or more files directly or indirectly depend on each other, and removing the circular dependency by removing an include statement from one of the two or more files that directly or indirectly depend on each other. In one embodiment, modifying the source code base comprises determining a first file includes a second file multiple times, and removing one or more include statements from the first file to cause the first file to include the second file only once.

According to one embodiment, a compile time of the modified code base is shorter than a compile time of the source code base. In one embodiment, the operations are repeated until there is no optimization between two consecutive iterations.

### BRIEF DESCRIPTION OF THE DRAWINGS

The invention may best be understood by referring to the following description and accompanying drawings that are used to illustrate embodiments of the invention. In the drawings:

FIG. 1 is a block diagram illustrating a system for optimizing a source code base, according to one embodiment.

FIG. 2A is a block diagram illustrating a source code base comprising of a hierarchies of include files, according to one embodiment.

FIG. 2B is a block diagram illustrating a directory structure according to one embodiment.

FIG. 3A is a block diagram illustrating a source code base comprising of include statements, according to one embodiment.

FIG. 3B is a block diagram illustrating a modified code base comprising of include statements that have been optimized to reduce variations of include paths, according to one embodiment.

FIG. 4A is a block diagram illustrating a source code base with a circular dependency, according to one embodiment.

FIG. 4B is a block diagram illustrating a modified code base with the circular dependency removed, according to one embodiment.

FIG. 5A is a block diagram illustrating a first file with multiple inclusions of a same second file, according to one embodiment.

FIG. 5B is a block diagram illustrating the first file with only one inclusion of the second file, and all other inclusions of the same second file removed, according to one embodiment.

FIG. 6 is a flow diagram illustrating a method for optimizing a source code base, according to one embodiment.

FIG. 7 is a block diagram illustrating an example of a data processing system which may be used with one embodiment of the invention.

### DESCRIPTION OF EMBODIMENTS

The following description describes methods and apparatuses for optimizing a source code base. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device or a computing device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set or one or more physical network interface(s) to establish network connections (to transmit and/or receive code and/or data using propagating signals) with other electronic devices. One or more parts of an embodiment of the invention may be implemented using different combinations of software, firmware, and/or hardware.

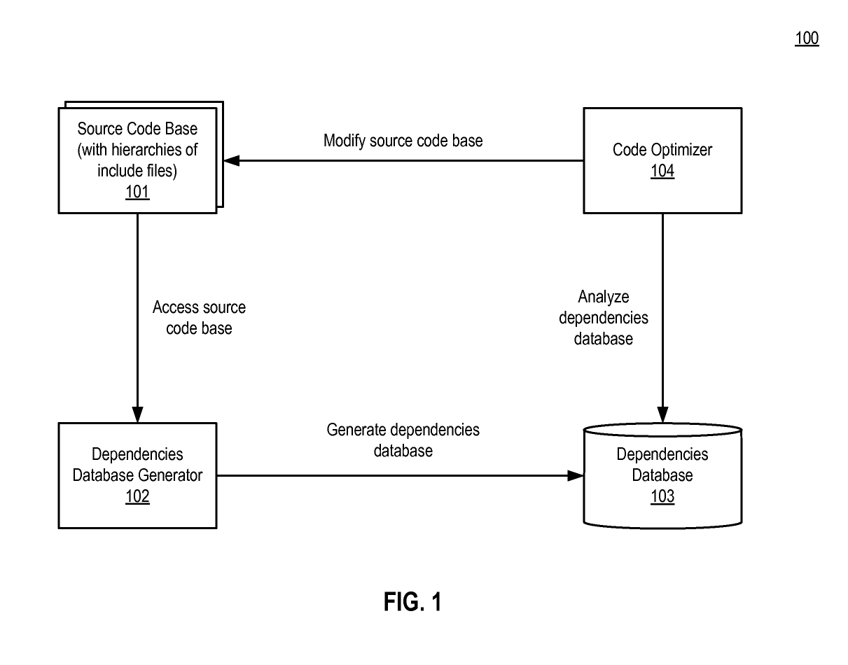

FIG. 1 is a block diagram illustrating system 100 (e.g., a processing or computing device) for optimizing a source code base, according to one embodiment. According to one embodiment, system 100 includes dependencies database generator (herein referred to simply as generator) 102 configured to read/access source code base 101. For example, source code base 101 may be stored in a storage device accessible by system 100. As used herein, a “source code base” refers to a collection source files and include files (herein interchangeably referred to as header files). In one embodiment, source code base 101 comprises hierarchies of include files. As used herein, a “hierarchy of include files” refers the notion that a source file includes one or more header files, and one or more of the included header files may include other header files, which in turn may include other header files, and so on, thus forming a hierarchy of include files.

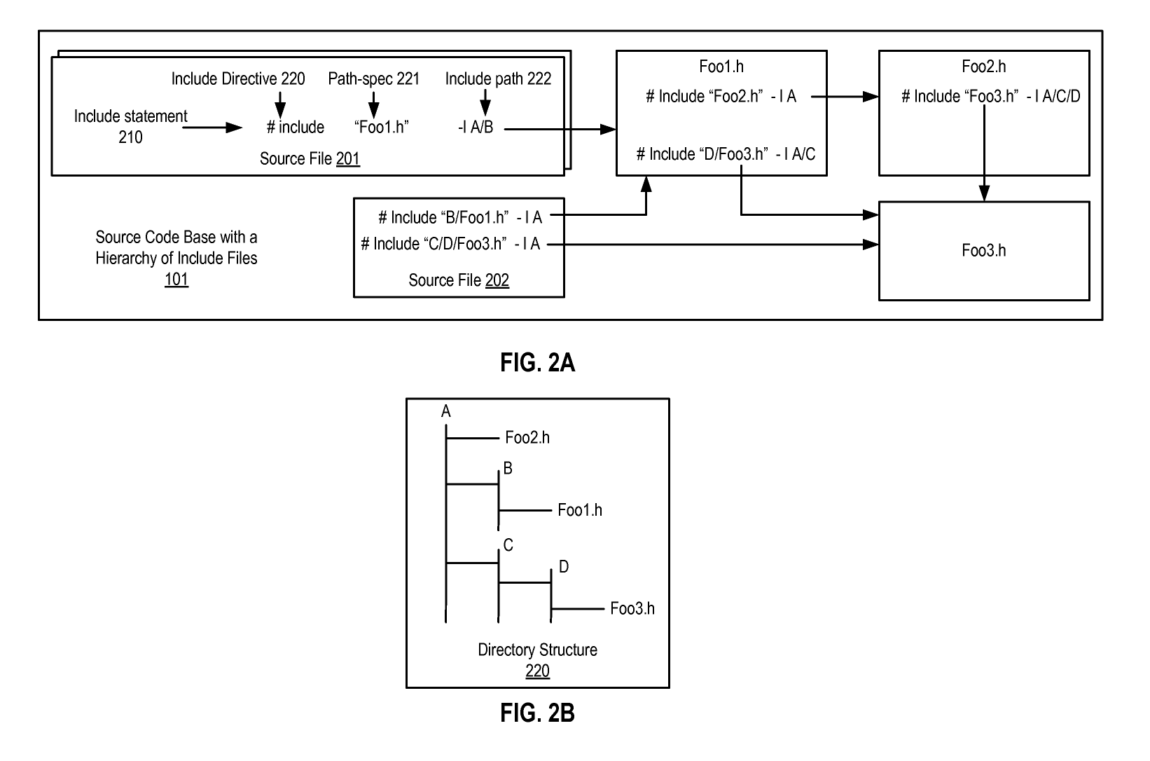

FIG. 2A is a block diagram illustrating source code base 101 according to one embodiment. The hierarchies of include files illustrated in FIG. 2A assume the header files are stored in directory structure 220, shown in FIG. 2B. As illustrated in directory structure 220, directory “A” includes sub directories “B” and “C”, and sub directory “C” includes sub directory “D”. In the illustrated directory structure, directory “A” contains header file “Foo2.h”, sub directory “B” contains header file “Foo1.h”, and sub directory “D” contains header file “Foo3.h”.

Referring now back to FIG. 2A, source code base 101 includes source files 201-202, each of which contains include statements that cause header files Foo1.h, Foo2.h, and Foo3.h to be included, thus forming hierarchies of include files. Each include statement comprises a predefined directive (e.g., “# include”), a path-spec, and an include path. The path-spec is a file name that may optionally be preceded by a directory path specification. The include path (herein interchangeably referred to as “-l”, i.e., a dash followed by the letter “l”) specifies a directory path that is to be prepended to the path-spec. The combination of the directory path specified by the include path and the optional directory path specified by the spec-path shall herein be referred to as the “link path”. Thus, the “# include” directive causes the header file residing at the link path (i.e., the location specified by the include path and the path-spec) to be included as part of the file which instantiates the include statement. In the illustrated embodiment, source file 201 contains include statement 210, which comprises include directive 220, path-spec 221, and include path 222. In this example, path-spec 221 indicates that header file “Foo1.h” is to be included, and include path 222 indicates that the directory path “A/B” is to be prepended to path-spec 221, which in this example, does not include the optional directory path. Thus, include directive 220 causes the header file “Foo1.h” located at directory “A/B” to be included in source file 201. In this example, the include path specifies the entire link path.

Continuing on with the example, header file “Foo1.h” contains two include statements. The first include statement causes header file “Foo2.h” residing at directory “A” to be included in header file “Foo1.h”. The second include statement causes header file “Foo3.h” residing at directory “A/C/D” to be included in header file “Foo1.h”. Header file “Foo2.h” contains an include statement that causes header file “Foo3.h” residing at directory “A/C/D” to be included in header file “Foo2.h”.

It should be noted here that in this example source file 201 directly depends on header file “Foo1.h”, and indirectly depends on header files “Foo2.h” and “Foo3.h”. In other words, source file 201 directly includes header file “Foo1.h”, and indirectly includes header files “Foo2.h” and “Foo3.h”. As used herein, “direct” dependence/inclusion refers to the dependence/inclusion on/of a header file at the first level of the hierarchy, and “indirect” dependence/inclusion refers to dependence/inclusion on/of a header file beyond the first level of the hierarchy. In this example, with respect to source file 201, header file “Foo1.h” is at the first level of the hierarchy, while the header files “Foo2.h” and Foo3.h” are at the second level of the hierarchy. Thus, source file 201 directly depends on (i.e., includes) header file “Foo1.h”, and indirectly depends on header files “Foo2.h” and “Foo3.h”.

Source code base 101 further includes source file 202, which contains two include statements. The first include statement causes header file “Foo1.h” to be included in source file 202. The second include statement causes header file “Foo3.h” to be included in source file 202. Thus, source file 202 directly depends on (i.e., includes) header files “Foo1.h” and “Foo3.h”. Further, source file 202 indirectly depends on header file “Foo2.h” because of the first include statement in header file “Foo1.h”.

Referring now back to FIG. 1, in one embodiment, generator 102 is configured to generate dependencies information of each source file and include file in source code base 101, and stores the dependencies information in dependencies database (herein referred to simply as database) 103. For example, database 103 can be stored in a storage device accessible by system 100. In one embodiment, the dependencies information associated with each source file or header file describes the dependency relationship between the source/header file and other header files in source code base 101. For example, in the hierarchies of include files illustrated in FIG. 2A, the dependencies information associated with source file 201 may indicate that source file 201 directly depends on header file “Foo1.h”. The dependencies information may further indicate that source file 201 indirectly depends on header files “Foo2.h” and “Foo3.h”. In alternate embodiment, the dependencies information associated with source file 201 does not include information concerning indirect dependencies (e.g., because such information can be inferred based on the dependencies information associated with the directly included header files.)

Referring now to FIG. 1, system 100 further includes code optimizer 104 for analyzing the dependencies information stored in database 103, and based on the analysis, optimizes source code base 101 by performing various modifications to the source files and/or header files. As used herein, “optimizing” refers to reducing compile/build time (i.e., reducing the amount of time required to compile and build source code base 101). In one embodiment, “optimizing” can refer to reducing the number of variations of include paths in source code base 101. In another embodiment, “optimizing” can also refer to removing circular dependencies. In yet another embodiment, “optimizing” can refer to removing of redundant inclusion of header files. Various embodiments of optimization are described in further details below. It shall be understood that the optimization embodiments described herein are for illustrative purposes, and are not intended to be limitations of the present invention. One having ordinary skill in the art would recognize that code optimizer 104 can be configured to optimize source code base 101 in various other ways in order to reduce compile/build time.

According to one embodiment, in response to determining a predetermined optimization threshold has not been reached, system 100 is configured to perform another iteration of code optimization. For example, the code optimization process described above can be repeated (e.g., automatically without any user intervention) until a certain optimization threshold (e.g., compile/build time) has been reached. In one embodiment, the optimization process can be repeated until a predetermined number of iterations have been reached, and/or a predetermined amount of time spent on optimization has been reached. Alternatively, or in addition to, the optimization process can be repeated until a predetermined number of consecutive of iterations (e.g., 2) have not produced any optimization. It should be understood that these predetermined conditions can be implemented individually or in any combination thereof.

In one embodiment, each optimization iteration is based on a modified code base from the previous iteration. For example, in the first iteration, generator 102 accesses the source code base as stored (e.g., by the user(s)) in a storage device accessible by system 100. Generator 102 generates and stores the dependencies information based on the accessed source code base in database 103. Code optimizer 104 analyzes the dependencies information and optimizes the source code base by performing various modifications to the source files and/or header files. The modified source code base is then stored in a storage device accessible by system 100. In one embodiment, code optimizer 104 overwrites the original source code base 101 with the modified code base. Alternatively, code optimizer 104 stores the modified code base in a different storage space in order to avoid overwriting the original source code base.

Regardless of where the modified code base is stored, during the second optimization iteration, generator 102 accesses the modified code base to generate and store the dependencies information in database 103. The dependencies information may overwrite the dependencies information generated during the first iteration, or stored in another storage space of database 103. Regardless of where the dependencies information of the second iteration are stored, code optimizer 104 then analyzes the dependencies information of the second iteration to optimize and modify the source code base. The optimization process then repeats again for one or more iterations until the predetermined optimization threshold has been reached, and/or one or more predetermined conditions have been satisfied. Various embodiments of code optimization shall now be described for illustrative purposes, and not intended to be limitations of the present invention.

Large code bases have many modules and sub modules underneath them organized into tree hierarchies with multiple branches, and different branches having different lengths. In such large code bases, many header files are distributed (i.e., included) in different branches of the tree, resulting in slower compile/build times and cannot scale well in a parallel environment because of cores competing for input/output (I/O) locks on the branches (directories) and leafs (files). To further exacerbate the problem of slower compile/build, a header file can have many variations in how it is included by other source units, and each variation will have a corresponding include path (-l) that requires the compiler to resolve in order for the correct header file to be included. Thus, different variations of include paths would ultimately result in a lot of -l paths for the compiler to resolve, thereby increasing the search space leading to the I/O congestion and slower builds.

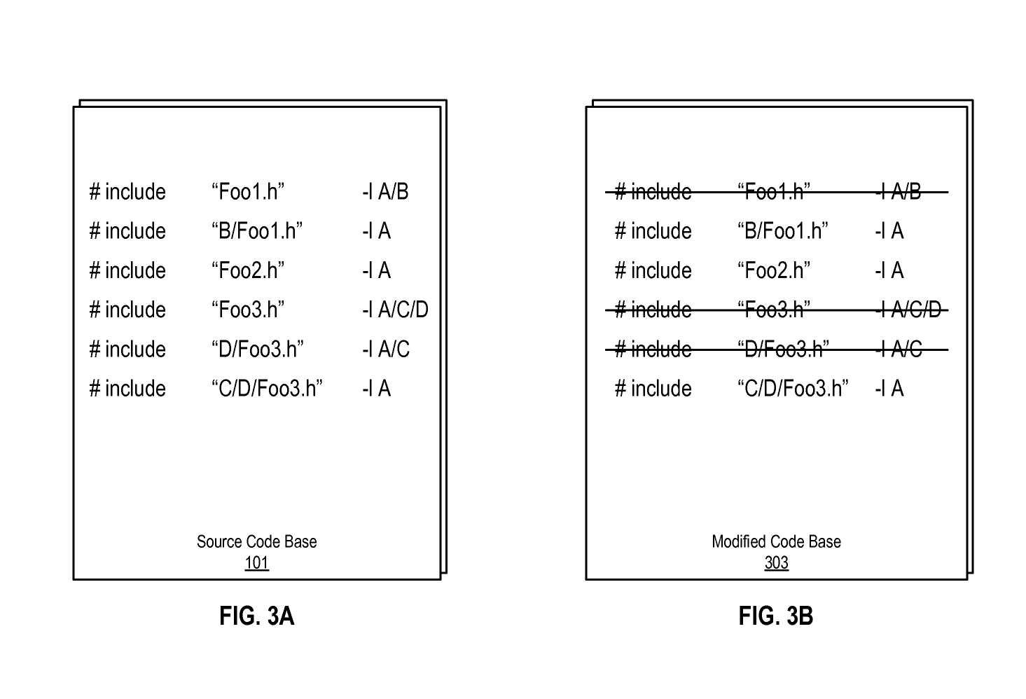

FIGS. 3A-3B are block diagrams illustrating source code bases with multiple include statements contained in one or more of the code base's source files and/or header files. FIGS. 3A-3B assume the hierarchies of include files illustrated in FIG. 2A. FIG. 3A illustrates the include statements of the source code base before optimization, and FIG. 3B illustrates the include instatements of the modified code base after optimization. Referring first to FIG. 3A, source code base 101 contains the following include statements:

# include “Foo1.h”-l A/B (1)
# include “B/Foo1.h”-l A (2)
# include “Foo2.h”-l A (3)
# include “Foo3.h”-l A/C/D (4)
# include “D/Foo3.h”-l A/C (5)
# include “C/D/Foo3.h”-l A (6)

For example, include statement (1) is contained in source file 201, include statement (2) is contained in source file 202, include statement (3) is contained in header file Foo1.h, include statement (4) is contained in header file Foo2.h, include statement (5) is contained in header file Foo1.h, and include statement (6) is contained in source file 202. It should be noted that although source code base 101 comprises of only 3 header files (i.e., Foo1.h, Foo2.h, and Foo3.h), there are 4 variations of how the 3 header files are included (i.e., there are 4 different variations of include paths). Specifically, the above example comprises of the following 4 variations of include paths:

### -l A/B (1)

### -l A (2)

### -l A/C/D (3)

### -l A/C (4)

The higher the number of variations in the include paths, the more time it will require the compiler to resolve the link paths, resulting in an increase in compile time. According to one embodiment, code optimizer 104 is configured to reduce the number of variations in the include paths of source code base 101. In one such embodiment, code optimizer 104 is to identify sets of include statements, wherein each set of include statements causes the same header file to be included. In the above example, the first set of include statements may comprise include statements (1) and (2) (because they cause the same header file “Foo1.h” to be included), the second set of include statement may comprise include statement (3), and the third set of include statements may comprise include statements (4), (5), and (6) (because they cause the same header file “Foo3.h” to be included).

In one embodiment, for each set of include statements, code optimizer 104 modifies the include statements to use the same path for all the include paths. In one such embodiment, code optimizer 104 modifies all the include paths of the set of include statements to be the root path. As used herein, a “root path” refers to the top of the hierarchy of a directory structure. For example, code optimizer 104 modifies the include statement in source file 201 from “# include “Foo1.h”-l A/B” to “# include “B/Foo1.h”-l A”. Further, code optimizer 104 modifies the include statements “# include D/Foo3.h”-l A/C” and “# include “Foo3.h”-l A/C/D” of header files “Foo1.h” and “Foo2.h”, respectively, to “# include “C/D/Foo3.h”-l A”.

Thus, after the optimization process, modified code base 303 comprises the following include statements:

# include “B/Foo1.h”-l A (1)
# include “B/Foo1.h”-l A (2)
# include “Foo2.h”-l A (3)
# include “C/D/F/Foo3.h”-l A (4)
# include “C/D/Foo3.h”-l A (5)
# include “C/D/Foo3.h”-l A (6)

In other words, modified code base 303 now comprises only these unique include statements:

# include “B/Foo1.h”-l A (1)

# include “Foo2.h”-l A (2)
# include “C/D/Foo3.h”-l A (3)

It should be noted that modified code base 303 includes only 1 variation of include path (i.e., -l “A”), and thus, its compile time is more optimized as compared to source code base 103, which includes 4 variations of include paths. It should be noted that the above optimization process can be performed in one or more iterations. For example, in each iteration, code optimizer 104 may optimize a predetermined number of sets of include statements. Further, the optimization process can be repeated until a predetermined number of sets of include statements have been modified. Alternatively, or in addition to, the optimization process can be repeated until a predetermined number of consecutive iterations have been performed in which no optimization resulted (e.g., no include statements were modified).

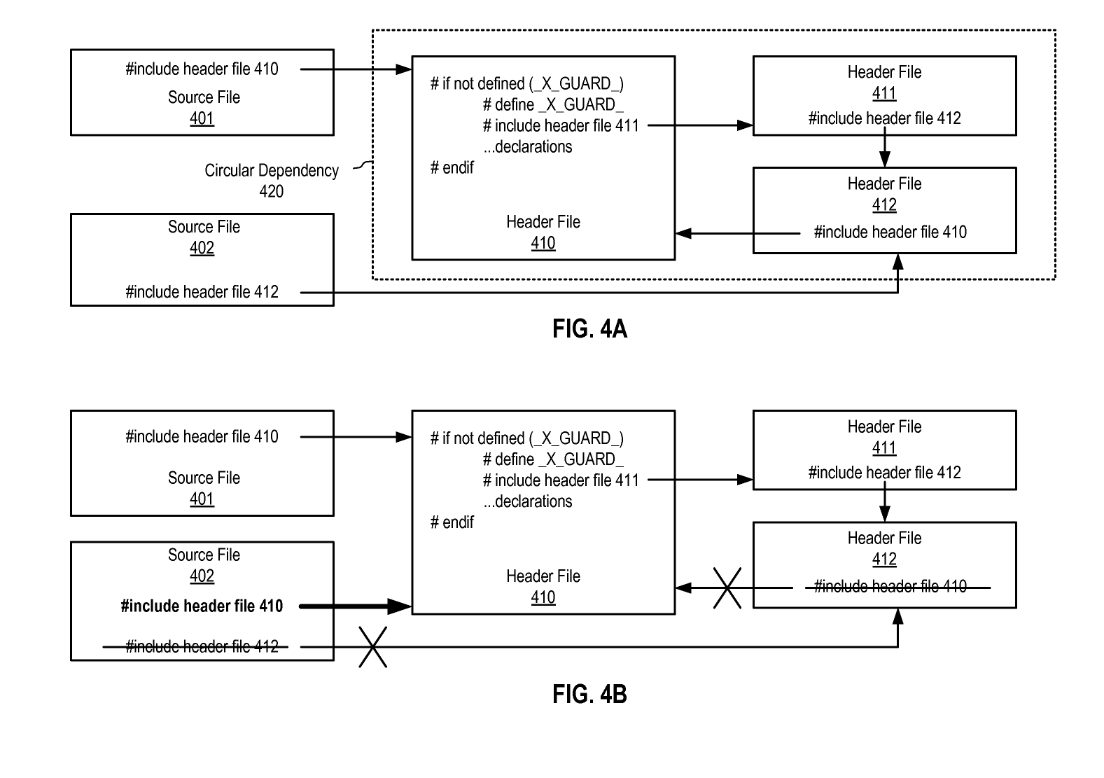

FIGS. 4A-4B are block diagrams illustrating a source code base that includes hierarchies of include files. FIG. 4A is a block diagram illustrating a hierarchy of include files with a circular dependency, and FIG. 4B is a block diagram illustrating the hierarchy of include files after the circular dependency has been removed.

Referring first to FIG. 4A. source file 401 contains an include statement that causes source file 401 to directly depend on header file 410. Header file 410 contains an include statement that causes header file 410 to directly depend on header file 411. As illustrated, header file 410 contains an include guard. As used herein, an “include guard” is a construct that is implemented/coded to avoid the problem of double/multiple inclusion of the same header file.

For example, the first time header file 410 is included (in this example, by source file 401), the contents (e.g., declarations) of header file 410 are included because the variable _X_GUARD_ is not yet defined. After the first inclusion of header file 410, the variable _X_GUARD_{—} is defined. In subsequent inclusion(s) of header file 410 (in this example, by header file 412), the contents of header file 410 are not re-included because the variable _X_GUARD_{—} is already defined by the first inclusion.

As illustrated, header file 411 contains an include statement that causes header file 411 to directly depend on header file 412. Although not shown, it should be understood that header file 411 may also contain an include guard. Header file 412 contains an include statement that causes header file 412 to directly depend on header file 410. Although not shown, it should be understood that header file 412 may also contain an include guard. The inclusion of header file 410 by header file 412 creates circular dependency 420. As used herein, a “circular dependency” refers to phenomenon where two or more files directly or indirectly depend on each other. In this example, header file 412 directly depends on header file 410, and header file 410 indirectly depends on header file 412.

It should be noted that with the help of the include guard in header file 410, the include statement in header file 412 does not cause a double inclusion of header file 410. Thus, from a functional perspective, circular dependency 420 does not cause a problem. Circular dependency 420, however, causes the compiler to resolve the unnecessary include statement contained in header file 412. Thus, from an optimization perspective, circular dependency 420 is a problem because it increases compile time.

According to one embodiment, code optimizer 104 is configured to identify/determine circular dependencies such as circular dependency 420 based on dependencies information stored in database 103. In one such embodiment, code optimizer 104 is to “break” (i.e., remove) the circular dependency by removing an include statement from a header file of the circular dependency. In one embodiment, code optimizer 104 identifies the include statement that is in the lowest level of the hierarchy of include files which causes the circular dependency, and removes the identified include statement. In this example, at the top of the hierarchy is source file 401, which includes header file 410, which includes header file 411, which includes header file 412. Thus, header file 412 is the lowest node/leaf in the hierarchy that contains the include statement which creates circular dependency 420.

As illustrated in FIG. 4B, in response to determining header file 412 is the lowest node/leaf in the hierarchy, code optimizer 104 removes the include statement it contains which creates circular dependency 420 (i.e., the include statement which causes header file 412 to depend on header file 410). By removing the include statement in header file 412, code optimizer 104 breaks/removes circular dependency 420. It should be noted that removing the include statement in header file 412 does not affect source file 401 because header file 410 has already been included by source file 401. The same cannot be said, however, for files that directly include the affected header file 412. As used herein, an “affected” header file refers to a header file in which an include statement has been removed in order to break a circular dependency. In the example illustrated in FIG. 4A, source file 402 directly depends on affected header file 412. By removing the include statement in header file 412, source file 402 no longer has access to the contents of header file 410 (or the contents of any of the header files that header file 410 directly and indirectly depends on).

In order to solve the problem described above, code optimizer 104 identifies all source nodes (whether it be a source file or a header file) which directly depend on an affected file, i.e., a file in which an include statement has been removed in order to break a circular dependency. In one such embodiment, code optimizer 104 replaces the include statement in the identified source node that causes the source node to directly depend on the affected header file, with the include statement that was removed from the affected header file. In this way, the source node now has direct access to the header file that it previously had indirect access to via the affected header file. In the example illustrated in FIG. 4B, the include statement in source file 402 that causes source file 402 to directly depend on affected header file 412 is replaced with the include statement that was removed from header file 412. As a result, source file 402 directly depends on (i.e., has direct access to) header file 410.

It should be noted that the optimization process described above for removing circular dependencies can be performed in multiple iterations. For example, one or more circular dependencies can be identified and removed in each iteration. The optimization process can be repeated until a predetermined number of circular dependencies have been removed. Alternatively, or in addition to, the optimization process can be performed until a predetermined number of consecutive iterations have been performed in which no optimization resulted (e.g., no circular dependency is detected).

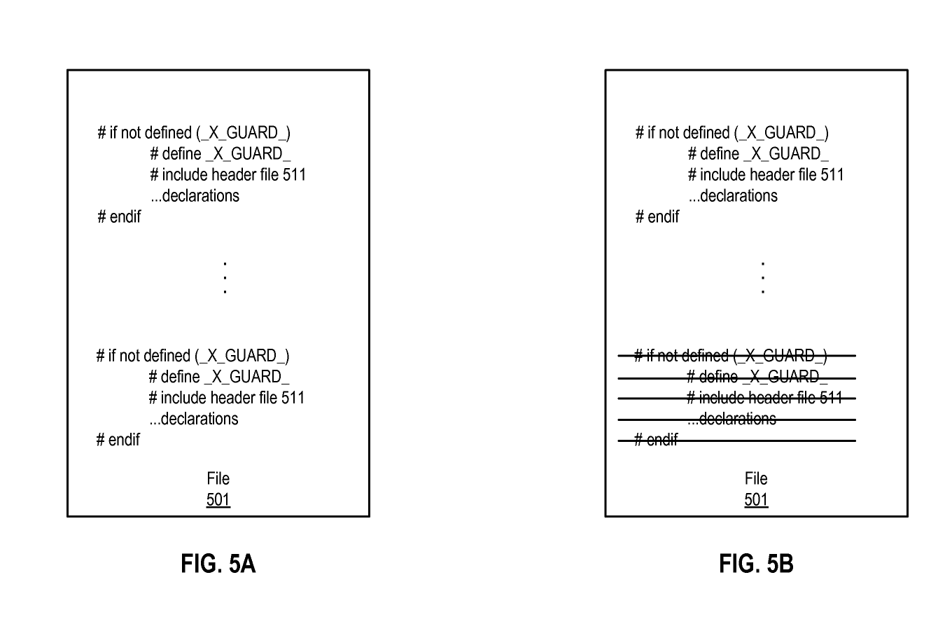

FIGS. 5A and 5B are block diagrams illustrating file 501, which can be a source file or a header file. FIG. 5A illustrates file 501 with multiple include statements that attempt to include the same header file 511. Such multiple instances of the same include statement may be the result of an error when file 501 was coded. For example, one user/coder may insert the first instance of the include statement, and another (or even the same) coder may subsequently insert the same include statement in another portion of file 501. Such multiple inclusions of the same header file do not affect functionality as long as the file contains include guards. As described above, an include guard ensures that only the first inclusion of the header file is performed. Multiple instances of the same include statement, however, causes a problem in terms of optimization because the compiler is required to resolve unnecessary include statements.

According to one embodiment, code optimizer 104 is configured to optimize the source code base by identifying files which contain multiple instances of the same inclusion using the dependencies information stored in database 103. In response to identifying a file with multiple instances of the same inclusion, code optimizer 104 is to maintain (i.e., keep) one instance of the include statement (e.g., the first instance), and remove all other instances of the same include statement. In this way, the compiler is not required to resolve unnecessary include statements, thus, reducing compile time. In the example illustrated in FIG. 5A, code optimizer 104 identifies 2 include statements that attempt to include the same header file 511. As illustrated in FIG. 5B, code optimizer 104 maintains one instance of the include statement, and removes the other instance of the same include statement.

It should be noted that the optimization process described above can be performed in multiple iterations. For example, a predetermined number of files can be processed in each iteration to determine whether multiple inclusions exist. One or more of such identified instances of multiple inclusions can be removed in each iteration. The optimization process can be performed until a predetermined number of multiple inclusions have been identified and resolved. Alternatively, or in addition to, the optimization process can be repeated until a predetermined number of iterations have been performed in which no optimization resulted (e.g., no multiple inclusions were detected and resolved).

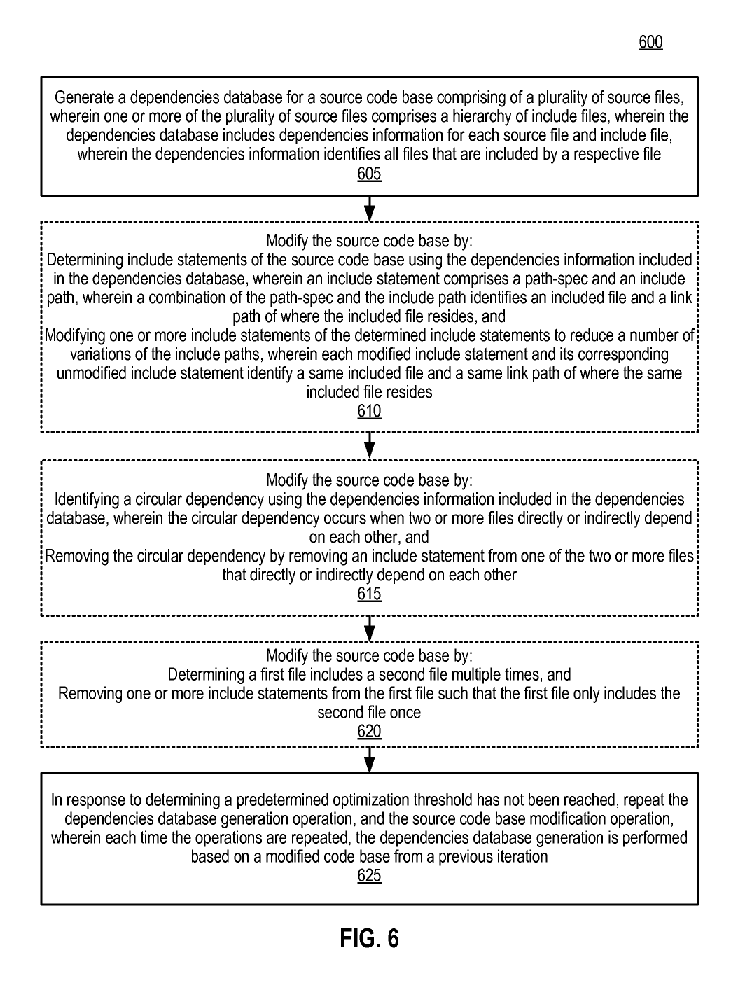

FIG. 6 is a flow diagram illustrating method 600 for optimizing a source code base. For example, method 600 can be performed by system 100. Method 600 can be implemented in software, firmware, hardware, or any combination thereof. The operations in this and other flow diagrams will be described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams.

Referring now to FIG. 6, at block 605, a system generates a dependencies database (e.g., database 103) for a source code base (e.g., source code base 101) comprising of a plurality of source files (e.g., source file 201-202), wherein one or more of the plurality of source files comprises a hierarchy of include files (e.g., “Foo1.h”, “Foo2.h”, “Foo3.h”), wherein the dependencies database includes dependencies information for each source file and include file, wherein the dependencies information identifies all files that are included by a respective file.

At optional block 610, the system analyzes the dependencies information and modifies the source code base, wherein the modified code base is more optimized than the source code base. As part of optional block 610, the system modifies the source code base by determining include statements of the source code base using the dependencies information included in the dependencies database, wherein an include statement comprises a path-spec and an include path, wherein a combination of the path-spec and the include path identifies an included file and a link path of where the included file resides. For example, system 100 determines that source code base 101 comprises include statements:

# include “Foo1.h”-l A/B (1)
# include “B/Foo1.h”-l A (2)
# include “Foo2.h”-l A (3)
# include “Foo3.h”-l A/C/D (4)
# include “D/Foo3.h”-l A/C (5)
# include “C/D/Foo3.h”-l A (6)

As part of optional block 610, the system modifies one or more include statements of the determined include statements to reduce a number of variations of the include paths, wherein each modified include statement and its corresponding unmodified include statement identify a same included file and a same link path of where the same included file resides. For example, system 100 modifies the above identified include statements to:

# include “B/Foo1.h”-l A (1)
# include “Foo2.h”-l A (2)
# include “C/D/Foo3.h”-l A (3)

At optional block 615, the system analyzes the dependencies information and modifies the source code base, wherein the modified code base is more optimized than the source code base. As part of optional block 615, the system identifies a circular dependency (e.g., circular dependency 420) using the dependencies information included in the dependencies database, wherein the circular dependency occurs when two or more files directly or indirectly depend on each other (e.g., header file 412 directly depends on header file 410, and header file 410 indirectly depends on header file 412). As part of optional block 615, the system removes the circular dependency by removing an include statement from one of the two or more files that directly or indirectly depend on each other. For example, system 100 removes the include statement in header file 412 that causes header file 412 to directly depend on header file 410 to remove/break circular dependency 420.

At optional block 620, the system analyzes the dependencies information and modifies the source code base, wherein the modified code base is more optimized than the source code base. As part of optional block 620, the system determines a first file (e.g., file 501) that includes a second file (e.g., file 511) multiple times, and removes one or more include statements from the first file such that the first file only includes the second file once. For example, system 100 maintains one instance of the include statement in file 501, and removes all other instances of the same include statement from file 501.

At block 625, in response to determining a predetermined optimization threshold has not been reached, the system repeats the dependencies database generation operation, and the source code base modification operation, wherein each time the operations are repeated, the dependencies database generation is performed based on a modified code base from a previous iteration.

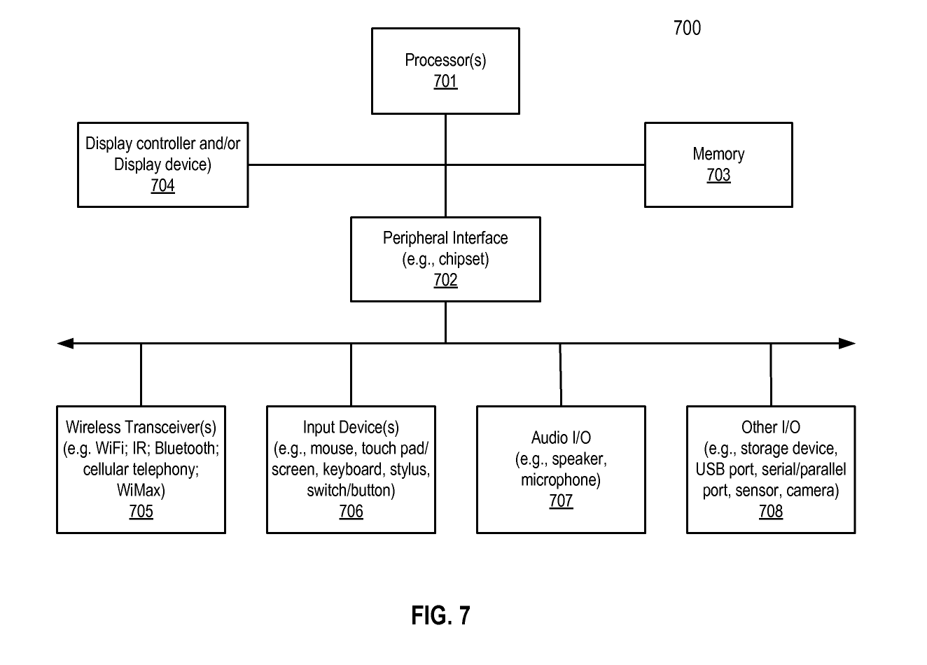

FIG. 7 is a block diagram illustrating an example of a data processing system which may be used with one embodiment of the invention. For example, system 700 may represent any of data processing systems described above performing any of the processes or methods described above. System 700 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof.

Referring to FIG. 7, in one embodiment, system 700 includes processor 701 and peripheral interface 702, also referred to herein as a chipset, to couple various components to processor 701 including memory 703 and devices 705-708 via a bus or an interconnect. Processor 701 may represent a single processor or multiple processors with a single processor core or multiple processor cores included therein. Processor 701 may represent one or more general-purpose processors such as a microprocessor, a central processing unit (CPU), or the like. More particularly, processor 701 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 701 may also be one or more special-purpose processors such as an application specific integrated circuit (ASIC), a field programmable gate array (FPGA), a digital signal processor (DSP), a network processor, a graphics processor, a network processor, a communications processor, a cryptographic processor, a co-processor, an embedded processor, or any other type of logic capable of processing instructions. Processor 701 is configured to execute instructions for performing the operations and steps discussed herein.

Peripheral interface 702 may include memory control hub (MCH) and input output control hub (ICH). Peripheral interface 702 may include a memory controller (not shown) that communicates with a memory 703. Peripheral interface 702 may also include a graphics interface that communicates with graphics subsystem 704, which may include a display controller and/or a display device. Peripheral interface 702 may communicate with graphics device 704 via an accelerated graphics port (AGP), a peripheral component interconnect (PCI) express bus, or other types of interconnects.

An MCH is sometimes referred to as a Northbridge and an ICH is sometimes referred to as a Southbridge. As used herein, the terms MCH, ICH, Northbridge and Southbridge are intended to be interpreted broadly to cover various chips who functions include passing interrupt signals toward a processor. In some embodiments, the MCH may be integrated with processor 701. In such a configuration, peripheral interface 702 operates as an interface chip performing some functions of the MCH and ICH. Furthermore, a graphics accelerator may be integrated within the MCH or processor 701.

Memory 703 may include one or more volatile storage (or memory) devices such as random access memory (RAM), dynamic RAM (DRAM), synchronous DRAM (SDRAM), static RAM (SRAM), or other types of storage devices. Memory 703 may store information including sequences of instructions that are executed by processor 701, or any other device. For example, executable code and/or data of a variety of operating systems, device drivers, firmware (e.g., input output basic system or BIOS), and/or applications can be loaded in memory 703 and executed by processor 701. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

Peripheral interface 702 may provide an interface to IO devices such as devices 705-708, including wireless transceiver(s) 705, input device(s) 706, audio IO device(s) 707, and other IO devices 708. Wireless transceiver 705 may be a WiFi transceiver, an infrared transceiver, a Bluetooth transceiver, a WiMax transceiver, a wireless cellular telephony transceiver, a satellite transceiver (e.g., a global positioning system (GPS) transceiver) or a combination thereof. Input device(s) 706 may include a mouse, a touch pad, a touch sensitive screen (which may be integrated with display device 704), a pointer device such as a stylus, and/or a keyboard (e.g., physical keyboard or a virtual keyboard displayed as part of a touch sensitive screen). For example, input device 706 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

Audio IO 707 may include a speaker and/or a microphone to facilitate voice-enabled functions, such as voice recognition, voice replication, digital recording, and/or telephony functions. Other optional devices 708 may include a storage device (e.g., a hard drive, a flash memory device), universal serial bus (USB) port(s), parallel port(s), serial port(s), a printer, a network interface, a bus bridge (e.g., a PCI-PCI bridge), sensor(s) (e.g., a motion sensor, a light sensor, a proximity sensor, etc.), or a combination thereof. Optional devices 708 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips.

Note that while FIG. 7 illustrates various components of a data processing system, it is not intended to represent any particular architecture or manner of interconnecting the components; as such details are not germane to embodiments of the present invention. It will also be appreciated that network computers, handheld computers, mobile phones, and other data processing systems which have fewer components or perhaps more components may also be used with embodiments of the invention.

Some portions of the preceding detailed descriptions have been presented in terms of algorithms and symbolic representations of transactions on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments of the present invention are not described with reference to any particular programming language. It will be appreciated that a variety of programming languages may be used to implement the teachings of embodiments of the invention as described herein.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

Throughout the description, embodiments of the present invention have been presented through flow diagrams. It will be appreciated that the order of transactions and transactions described in these flow diagrams are only intended for illustrative purposes and not intended as a limitation of the present invention. One having ordinary skill in the art would recognize that variations can be made to the flow diagrams without departing from the broader spirit and scope of the invention as set forth in the following claims.

What is claimed is:

1. A computer-implemented comprising:
generating a dependencies database for a source code base comprising of a plurality of source files, wherein one or more of the plurality of source files comprises a hierarchy of include files, wherein the dependencies database includes dependencies information for each source file and include file, wherein the dependencies information identifies all files that are included by a respective file;
modifying the source code base using the dependencies information, wherein the modified code base is more optimized than the source code base; and
in response to determining a predetermined optimization threshold has not been reached, repeating the dependencies database generation operation and the source code base modification operation, wherein each time the operations are repeated, the dependencies database generation is performed based on a modified code base from a previous iteration.

2. The method of claim 1, wherein modifying the source code base comprises:
determining include statements of the source code base using the dependencies information included in the dependencies database, wherein an include statement comprises a path-spec and an include path, wherein a combination of the path-spec and the include path identifies an included file and a link path of where the included file resides; and
modifying one or more include statements of the determined include statements to reduce a number of variations of the include paths, wherein each modified include statement and its corresponding unmodified include statement identify a same included file and a same link path of where the same included file resides.

3. The method of claim 2, wherein modifying one or more include statements comprises:
determining a root path of a set of one or more include statements of the determined include statements; and
modifying the set of one or more include statements to use the determined root path as the include path.

4. The method of claim 1, wherein modifying the source code base comprises:
identifying a circular dependency using the dependencies information included in the dependencies database, wherein the circular dependency occurs when two or more files directly or indirectly depend on each other; and
removing the circular dependency by removing an include statement from one of the two or more files that directly or indirectly depend on each other.

5. The method of claim 1, wherein modifying the source code base comprises:
determining a first file includes a second file multiple times; and
removing one or more include statements from the first file to cause the first file to include the second file only once.

6. The method of claim 1, wherein a compile time of the modified code base is shorter than a compile time of the source code base.

7. The method of claim 1, wherein the operations are repeated until there is no optimization between two consecutive iterations.

8. An apparatus comprising:
a set of one or more processors; and
a non-transitory machine-readable storage medium containing code, which when executed by the set of one or more processors, cause the apparatus to:
generate a dependencies database for a source code base comprising of a plurality of source files, wherein one or more of the plurality of source files comprises a hierarchy of include files, wherein the dependencies database includes dependencies information for each source file and include file, wherein the dependencies information identifies all files that are included by a respective file,
modify the source code base using the dependencies information, wherein the modified code base is more optimized than the source code base, and
in response to determining a predetermined optimization threshold has not been reached, repeat the dependencies database generation operation and the source code base modification operation, wherein each time the operations are repeated, the dependencies database generation is performed based on a modified code base from a previous iteration.

9. The apparatus of claim 8, wherein modifying the source code base comprises the apparatus to:
determine include statements of the source code base using the dependencies information included in the dependencies database, wherein an include statement comprises a path-spec and an include path, wherein a combination of the path-spec and the include path identifies an included file and a link path of where the included file resides; and
modify one or more include statements of the determined include statements to reduce a number of variations of the include paths, wherein each modified include statement and its corresponding unmodified include statement identify a same included file and a same link path of where the same included file resides.

10. The apparatus of claim 9, wherein modifying one or more include statements comprises the apparatus to:
determine a root path of a set of one or more include statements of the determined include statements; and
modify the set of one or more include statements to use the determined root path as the include path.

11. The apparatus of claim 8, wherein modifying the source code base comprises the apparatus to:
identify a circular dependency using the dependencies information included in the dependencies database, wherein the circular dependency occurs when two or more files directly or indirectly depend on each other; and
remove the circular dependency by removing an include statement from one of the two or more files that directly or indirectly depend on each other.

12. The apparatus of claim 8, wherein modifying the source code base comprises the apparatus to:
determine a first file includes a second file multiple times; and
remove one or more include statements from the first file to cause the first file to include the second file only once.

13. The apparatus of claim 8, wherein a compile time of the modified code base is shorter than a compile time of the source code base.

14. The apparatus of claim 8, wherein the operations are repeated until there is no optimization between two consecutive iterations.

15. A non-transitory computer-readable storage medium having computer code stored therein, which when executed by a processor of an apparatus, cause the apparatus to perform operations comprising:
generating a dependencies database for a source code base comprising of a plurality of source files, wherein one or more of the plurality of source files comprises a hierarchy of include files, wherein the dependencies database includes dependencies information for each source file and include file, wherein the dependencies information identifies all files that are included by a respective file;
modifying the source code base using the dependencies information, wherein the modified code base is more optimized than the source code base; and
in response to determining a predetermined optimization threshold has not been reached, repeating the dependencies database generation operation and the source code base modification operation, wherein each time the operations are repeated, the dependencies database generation is performed based on a modified code base from a previous iteration.

16. The non-transitory computer-readable storage medium of claim 15, wherein modifying the source code base comprises:
determining include statements of the source code base using the dependencies information included in the dependencies database, wherein an include statement comprises a path-spec and an include path, wherein a combination of the path-spec and the include path identifies an included file and a link path of where the included file resides; and
modifying one or more include statements of the determined include statements to reduce a number of variations of the include paths, wherein each modified include statement and its corresponding unmodified include statement identify a same included file and a same link path of where the same included file resides.

17. The non-transitory computer-readable storage medium of claim 16, wherein modifying one or more include statements comprises:
determining a root path of a set of one or more include statements of the determined include statements; and
modifying the set of one or more include statements to use the determined root path as the include path.

18. The non-transitory computer-readable storage medium of claim 15, wherein modifying the source code base comprises:
identifying a circular dependency using the dependencies information included in the dependencies database, wherein the circular dependency occurs when two or more files directly or indirectly depend on each other; and
removing the circular dependency by removing an include statement from one of the two or more files that directly or indirectly depend on each other.

19. The non-transitory computer-readable storage medium of claim 15, wherein modifying the source code base comprises:
determining a first file includes a second file multiple times; and
removing one or more include statements from the first file to cause the first file to include the second file only once.

20. The non-transitory computer-readable storage medium of claim 15, wherein a compile time of the modified code base is shorter than a compile time of the source code base.

21. The non-transitory computer-readable storage medium of claim 15, wherein the operations are repeated until there is no optimization between two consecutive iterations.
